(19) United States
(12) Patent Application Publication
(10) Pub. No.: US 2023/0183917 A1
(43) Pub. Date: Jun. 15, 2023

(54) FABRIC COMPRISING GRAPHENE, METHOD OF PREPARATION, AND APPLICATIONS THEREOF

(71) Applicant: RELIANCE INDUSTRIES LIMITED, Mumbai (IN)

(72) Inventors: Joseph Berkmans AMIRTHASAMY, Sivaganaga (IN); Animesh LAHA, Hooghly (IN); Vivek Prabhakar RAJE, Palava City (IN); Debarati Roy CHOUDRY, Kolkata (IN); Mahendra Kumar SHUKLA, Ahmedabad (IN); Prateek NIGAM, Ahmedabad (IN); Sushant Suresh REKHI, Dombivli (East) (IN); Vijai Shankar BALACHANDRAN, Vellore (IN); Moumita NANDY, Barrackpore (IN); Kaustav GOSWAMI, Krishnapur (IN)

(21) Appl. No.: 17/913,616

(22) PCT Filed: Feb. 23, 2021
(86) PCT No.: PCT/IB2021/051495

§ 371 Date: Sep. 22, 2022

(30) Foreign Application Priority Data
Mar. 23, 2020 (IN) 202021012689
Mar. 24, 2020 (IN) 202021012735

(51) Int. Cl. D06M 11/74; C01B 32/194; C09D 1/00; C09D 7/45; C09D 7/80; D06M 16/00

(52) U.S. Cl. CPC D06M 11/74; C01B 32/194; C09D 1/00; C09D 7/45; C09D 7/80; D06M 16/00; D06M 2101/32; D06M 2200/00; D06M 2200/25

(57) ABSTRACT

The present disclosure provides fabrics comprising graphene and/or its derivative(s), wherein said graphene comprising fabrics are characterized by at least three features selected from anti-microbial, antistatic, wicking, thermal cooling, anti-odour and ultraviolet protection. Said graphene comprising fabrics of the present disclosure show several further beneficial properties including but not limited to good/excellent washing fastness, rubbing fastness, perspiration fastness, sublimation fastness and light fastness.

### TECHNICAL FIELD

The present disclosure generally relates to the field of textile technology and pertains to fabrics possessing at least three features selected from anti-microbial, antistatic, wicking, thermal cooling, anti-odour and ultraviolet protection. More particularly, the present disclosure provides fabrics comprising graphene and/or its derivative(s), wherein said graphene comprising fabrics are characterized by at least three features selected from anti-microbial, antistatic, wicking, thermal cooling, anti-odour and ultraviolet protection. Said graphene comprising fabrics of the present disclosure show several further beneficial properties including but not limited to good/excellent washing fastness, rubbing fastness, perspiration fastness, sublimation fastness and light fastness.

### BACKGROUND OF THE DISCLOSURE

Fabrics (synthetic, natural and their blends) such as polyester are widely used as garment materials, sports wears, apparels in hospitals, medical devices, air purifiers and auto motive textile applications due to its high tenacity and durability. However, virgin fabrics have tendency to absorb moisture and grow microorganisms such as bacteria and fungi on their surface and don’t have any inherent ability to hamper the growth of microorganisms. Such microorganisms cause adverse effects to the textiles and the consumers. Many anti-microbial agents and their use in preparing anti-microbial textiles are known. For instance, silver nanoparticles are known to be effective and is a widely studied anti-microbial agent for textile applications. However, cost and the release of the metallic nanoparticles to the environment remain to be challenges.

Synthetic Fabrics (such as polyester) and their blends are widely used as garment materials and auto motive textile applications due to its high tenacity and durability. Unprocessed grey polyester fabrics accumulate static charges on their surface naturally which affects the comfort of the fabric in many applications such as apparels. Anti-static agents generally employed in the art typically increase the electrical conductivity of the fabric by forming hygroscopic intermediate layers on the fabric surface that absorb moisture and enhance conductivity. However, said absorption of moisture for achieving anti-static effect interferes with properties such as wicking and thermal cooling. Said properties of wicking and thermal cooling are extremely important for the comfort of the wearer especially in the case of garments such as sports wear wherein anti-microbial effect of the fabric is also important for purposes of hygiene.

Taken together, there is a requirement for fabrics possessing a combination of multiple beneficial characteristics as a whole, wherein all characteristics exist simultaneously without interfering with each other. The present disclosure tries to address said need.

### SUMMARY OF THE DISCLOSURE

Addressing the aforesaid need in the art, the present disclosure provides a fabric comprising graphene at an amount ranging from about 0.005% (w/w) to 1% (w/w), said fabric characterized by a combination of at least three features selected from antimicrobial, antistatic, anti-odour, wicking, thermal cooling and ultraviolet protection.

In some embodiments, the fabric is selected from the group comprising natural fabric, synthetic fabric, a blend of natural fabric and synthetic fabric, and combinations thereof; and the graphene is a graphene, a graphene derivative or a combination thereof.

In some embodiments, the fabric comprises bactericidal or antibacterial effect, bacteriostatic effect, antiviral effect, antifungal effect or combinations thereof; wherein the fabric is characterized by a bactericidal effect ranging from about 90% to 99.999% against Staphylococcus aureus, Klebsiella pneumonia, and Escherichia coli; wherein the fabric is characterized by a bacteriostatic effect ranging from about 90% to 99.999% against Staphylococcus aureus, Klebsiella pneumonia, and Escherichia coli; wherein the fabric is characterized by an antiviral effect ranging from about 90% to 99.999% against MS2 bacteriophage; or wherein the fabric is characterized by an antifungal effect ranging from about 90% to 99.999% against Aspergillus Niger and Candida Albicans.

In some embodiments, the fabric is characterized by half decay time for discharge of charge applied on the fabric surface which ranges from about 0.1 seconds to 3 seconds, anti-odour effect measured by AATCC 100 standard which ranges from about 90% to 99.999%, wicking effect measured by AATCC 197:2013 standard which ranges from about 2 inches/3 minutes to about 5 inches/30 minutes, thermal cooling measured by Q-Max which ranges from about 0.1 watts per square centimeter (W/cm²) to 0.7 W/cm², and ultraviolet protection measured by ultraviolet protection factor (UPF) which ranges from about 30 to 70.

The said fabric, in some embodiments, has a washing fastness, perspiration fastness, sublimation fastness and light fastness of about 4 to 5; and water absorbency of 0.1 Sec to 5 Sec.

In some embodiments, the antimicrobial, antistatic, anti-odour, wicking, thermal cooling and ultraviolet protection features of the fabric of the present disclosure are maintained after 30 washes or more.

The present disclosure further provides a method of preparing a fabric comprising graphene, said fabric characterized by a combination of at least three features selected from antimicrobial, antistatic, anti-odour, wicking, thermal cooling and ultraviolet protection, the method comprising contacting graphene at an amount ranging from about 0.005% (w/w) to 1% (w/w) with a fabric.

In some embodiments, contacting the graphene comprises:
a) preparing a coating solution comprising graphene slurry; and
b) contacting the fabric with the coating solution, to prepare the fabric comprising graphene.

In some embodiments, the coating solution is prepared by:
i) dispersing graphene in a solvent and optionally a surfactant followed by mixing, to prepare the graphene slurry; and
ii) mixing the graphene slurry with at least two agents selected from the group comprising wetting agent, dispersing agent, lubricating agent, defoaming agent, pH control agent, fabric coating agent, and combinations thereof.

In an embodiment, the method coats the graphene on the surface of the fabric or infuses the graphene onto the fibre network of the fabric, or a combination of both.

The present disclosure further provides use of graphene at an amount ranging from about 0.005 to 1% (w/w) for preparing a fabric characterized by a combination of at least three features selected from antimicrobial, antistatic, anti-odour, wicking, thermal cooling and ultraviolet protection.

Further provided is a graphene coating solution comprising graphene and at least two agents selected from the group comprising wetting agent, dispersing agent, lubricating agent, defoaming agent, pH control agent, fabric coating agent and combinations thereof, wherein the wetting agent, the dispersing agent, the lubricating agent, the defoaming agent and the pH control agent is as defined in the preceding claims.

The present disclosure also provides a method of preparing the graphene coating solution as described above, the method comprising:
i) dispersing graphene in a solvent and optionally a surfactant followed by mixing, to prepare a graphene slurry; and
ii) mixing the graphene slurry with at least two agents selected from the group comprising wetting agent, dispersing agent, lubricating agent, defoaming agent, pH control agent, fabric coating agent, and combinations thereof; and wherein the graphene, solvent, surfactant, wetting agent, dispersing agent, lubricating agent, defoaming agent, pH control agent and the fabric coating agent are as defined in the preceding claims.

### BRIEF DESCRIPTION OF THE ACCOMPANYING FIGURES

The patent or application file contains at least one drawing executed in color. Copies of this patent or patent application publication with color drawing(s) will be provided by the Office upon request and payment of the necessary fee.

In order that the disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages, in accordance with the present disclosure where:

FIG. 1 depicts the dyeing cycle employed for dyeing/coating the fabric with the coating solution comprising graphene.

FIG. 2 depicts the reduction clearing cycle that the fabric is subjected to after the dyeing cycle.

### DETAILED DESCRIPTION OF THE DISCLOSURE

In view of the limitations discussed above, and to remedy the need in the art for fabric products characterized by multiple properties such as a combination of at least three features selected from anti-microbial, anti-static, anti-odour, wicking, thermal cooling and ultraviolet protection, the present disclosure aims to provide a fabric comprising graphene at a controlled concentration. In particular, the present disclosure relates to a fabric comprising graphene and/or its derivatives incorporated into it. Said incorporation of the graphene may be on the surface level or may be internally infused or absorbed into the fabric. The disclosure also provides a corresponding process for preparing such graphene containing fabric product and corresponding beneficial properties obtained thereof.

However, before describing the invention in greater detail, it is important to take note of the common terms and phrases that are employed throughout the present disclosure for better understanding of the technology provided herein.

Throughout the present disclosure, the term ‘graphene’ is intended to convey the ordinary conventional meaning of the term known to a person skilled in the art and intends to cover ‘graphene’ as an allotrope of carbon consisting of a single or multiple layers of carbon atoms. Thus, the graphene employed in the present disclosure may be a single layered or multi layered graphene. The graphene employed herein is preferably of high surface area, typically ranging between 100 m²/g to 2000 m²/g, more typically between 300 m²/g to 800 m²/g. In non-limiting embodiments, the surface area of graphene incorporated into the fabric of the present disclosure is about 100 m²/g, about 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g or 2000 m²/g.

Throughout the present disclosure, the term ‘graphene derivatives’, ‘derivatives of graphene’ or the likes is intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass monolayer graphene, bilayer graphene, trilayer graphene, few layer graphene, multi-layer graphene, graphene nanoplatelets, graphene oxides, reduced graphene oxides, functionalized graphene, graphene decorated with metal particles, nanosized graphene, graphene quantum dots or any graphene containing material.

In embodiments of the disclosure, graphene derivatives encompass functionalized graphene. Further, said term ‘functionalized’ or ‘functionalization’ is used interchangeably and is intended to convey the ordinary conventional meaning of the term known to a person skilled in the art in the field of polymer or material science, and intends to cover a process of adding new functions, features, capabilities, or properties to a material by changing the surface chemistry of the material. In the context of graphene employed in the present disclosure, the term is used to cover functionalization of graphene including reactions of graphene (and its derivatives) with organic and/or inorganic molecules, chemical modification of the graphene surface, and the interaction of various covalent and noncovalent components with graphene.

The functionalization of graphene is surface modification used to reduce the cohesive force between the graphene sheets and to manipulate the physical and chemical properties of graphene.

Throughout the present disclosure, the terms ‘fabric’, ‘fibre’, ‘yarn’, ‘textile’, ‘cloth’ or the likes are intended to convey the ordinary conventional meaning of the terms known to a person skilled in the art and intends to cover natural fabric, synthetic fabric and blends of natural and/or synthetic fabric. In some embodiments of the disclosure, the term ‘fabric’ also encompasses ‘fibres’ or ‘yarn’ forming said fabric. Accordingly, in the context of the present disclosure, reference to ‘graphene-containing fabric’ envisages in ‘graphene-containing fibre’ and ‘graphene-containing yarn’. Further, ‘fabric’ encompasses unprocessed/virgin fabric and/or processed/partially processed fabric.

Throughout the present disclosure, the terms/phrases ‘graphene infused fabric’ or ‘graphene incorporated fabric’ or ‘graphene coated fabric’ or ‘fabric comprising graphene’ or ‘graphene-containing fabric’ are used interchangeably and refer to the feature of fabric comprising graphene introduced/coated/impregnated onto it.

As used herein, the term ‘fabric coating agent’ refers to agents routinely used to coat fabric to yield longer lasting, stronger, and more weather resistant fabric. In the context of the present disclosure, it refers to standard/conventional coating agents optionally added to the coating solution, apart from those explicitly mentioned herein.

As used herein, the phrase ‘coated with’ while referring to the fabric or fibres of the present disclosure coated with graphene refers to fabric or fibres, the surface of with is coated with graphene or derivatives thereof.

The term ‘anti-microbial’ and obvious variants thereof as used in the present disclosure, refers to the characteristic of the fabric of the present disclosure that exerts destructive or inhibitory effect on the growth of microorganisms, including bacteria, viruses, and fungi.

As used herein, the term ‘anti-bacterial’ refers to bacteriostatic or bactericidal activity of the fabric, wherein ‘bacteriostatic’ typically means that the agent prevents the growth of bacteria (i.e., it keeps them in the stationary phase of growth), and ‘bactericidal’ means that it kills bacteria. In reality, there are not 2 pure categories of antimicrobial agents (one that exclusively kills bacteria and another that only inhibits growth). Most anti-bacterials are better described as potentially being both bactericidal and bacteriostatic.

As used herein, the term ‘anti-viral’ refers to the ability of the fabric to kill a virus or suppress its ability to replicate and, hence, inhibits its capability to multiply and reproduce.

As used herein, the term ‘ant-fungal’ refers to the ability of the fabric to limit or prevent the growth of yeasts and other fungal organisms.

The term ‘anti-static’ and obvious variants thereof refer to the characteristic of the fabric of the present disclosure typically relating to reduction or elimination of build-up of static electricity.

The term ‘wicking’ and obvious variants thereof refer to a technical feature of the fabric of the present disclosure which draws moisture away from the body.

The term ‘thermal cooling’ and obvious variants thereof refer to the characteristic of the fabric that allows thermal regulation due to the thermal conductivity of the fabric. Said feature allows body heat to pass through the fabric by conduction/convection to the ambient environment.

The term ‘UV protection’ and obvious variants thereof refer to the protective effect exerted by the fabric against sun’s ultraviolet (UV) radiation. Unless otherwise mentioned, Ultraviolet Protection Factor (UPF) is used as a measuring parameter of the ‘UV protection’ characteristic of the fabric.

‘Washing fastness’ refers to the ability of the fabric to maintain the original colour under the washing condition, that is, the ability of not fading and changing colour.

‘Rubbing fastness’ refers to the resistance to fading of dyed fabric when subjected to dry-rubbing or wet-rubbing. It is considered as a measure of colourfastness of fabric and is typically measured by use of crockmeter.

‘Perspiration fastness’ refers to the ability of the fabric to not fade and not stain when dyed fabric is perspired.

‘Sublimation fastness’ refers to the ability of high temperature resistance and colour fastness of the fabric under heat pressure or heat drum process.

‘Light fastness’ or ‘Lightfastness’ is the resistance of a colourant such as dye or pigment present in the fabric to fading when it is when exposed to light.

‘Blend’ it the context of the present disclosure refers to ‘blended fabric’ or a ‘fabric blend’, wherein said blended fabric is formed from fibres or yarn formed by combining fibres of different origins, length, thickness, or colour.

In the context of the present disclosure, the terms ‘coating’ and ‘dyeing’ have been used interchangeably to refer to the process feature of application of graphene to the fabric to form the graphene incorporated fabric of the present disclosure.

The terms ‘coating solution’ and ‘graphene coating solution’ as referred to herein refer to the graphene containing solution applied to the fabric of the present disclosure that comprises graphene and/or its derivatives along with two or more coating or dyeing agents/components. Though referred to as a ‘coating’ solution, said coating solution may suitably be employed in ‘dyeing’ or ‘coating’ of fabric to obtain the graphene incorporated fabric of the present disclosure. Accordingly, there is no limitation on the mode of application of the coating solution the fabric.

Accordingly, to reiterate, the present disclosure relates to a fabric product comprising graphene and/or its derivatives infused or incorporated in it, wherein said fabric is specifically characterized by a combination of at least three features selected from anti-microbial, antistatic, anti-odour, wicking, thermal cooling and ultraviolet protection.

Particularly provided by the present disclosure is a fabric comprising graphene at an amount ranging from about 0.005% (w/w) to 1% (w/w), said fabric characterized by a combination of at least three features selected from anti-microbial, antistatic, anti-odour, wicking, thermal cooling and ultraviolet protection.

In some embodiments, the present disclosure relates to fibre(s) comprising graphene at an amount ranging from about 0.005% (w/w) to 1% (w/w), said fibre(s) characterized by a combination of at least three features selected from anti-microbial, antistatic, anti-odour, wicking, thermal cooling and ultraviolet protection.

In some embodiments, the present disclosure relates to yarn(s) comprising graphene at an amount ranging from about 0.005% (w/w) to 1% (w/w), said yarn(s) is characterized by a combination of at least three features selected from anti-microbial, antistatic, anti-odour, wicking, thermal cooling and ultraviolet protection.

As defined above, the graphene incorporated fabric comprises graphene and/or its derivatives at a concentration ranging from about 0.005 % (w/w) to 1 % (w/w) with respect to the weight of the fabric, including all values or ranges derivable therefrom. Said graphene-containing fabric of the present disclosure is further characterized by the mandatory presence of a combination of at least three features selected from anti-microbial, antistatic, anti-odour, wicking, thermal cooling and ultraviolet protection.

In some embodiments, the graphene incorporated fabric of the present disclosure comprises graphene and/or its derivatives at a concentration ranging from about 0.005 % (w/w) to 1 % (w/w) with respect to the weight of the fabric, including all values or ranges derivable therefrom and a combination of at least four features selected from anti-microbial, antistatic, anti-odour, wicking, thermal cooling and ultraviolet protection.

In some embodiments, the graphene incorporated fabric of the present disclosure comprises graphene and/or its derivatives at a concentration ranging from about 0.005 % (w/w) to 1 % (w/w) with respect to the weight of the fabric, including all values or ranges derivable therefrom and a combination anti-microbial, antistatic, anti-odour, wicking, thermal cooling and ultraviolet protection features.

In some embodiments, the present disclosure provides a Fabric having any combination of features selected from the combinations indicated in Table 1. In Table 1, X represents presence of the feature as part of the combination encompassed in each row. Accordingly, every single combination provided in Table 1 represents a separate embodiment of the present disclosure. However, the present disclosure also envisages a merger or mixture of these embodiments to provide for further possible combinations. Thus, for the purposes of the present disclosure, each of the combinations that are derivable from Table 1 below are envisaged to exist individually, all together or in different combinations within the ambit of the present disclosure.

TABLE 1

| | | | | | | | |
|---|---|---|---|---|---|---|---|
| Fabric | Graphene at an amount ranging from about 0.005% (w/w) to 1% (w/w) | Anti-microbial | Antistatic | Anti-odour | Wicking | Thermal cooling | Ultraviolet protection |
| Fabric A | X | X | X | X | | | |
| Fabric B | X | X | X | | X | | |
| Fabric C | X | X | X | | | X | |
| Fabric D | X | X | X | | | | X |
| Fabric E | X | X | | X | X | | |
| Fabric F | X | X | | X | | X | |
| Fabric G | X | X | | X | | | X |
| Fabric H | X | X | | | X | X | |
| Fabric I | X | X | | | X | | X |
| Fabric J | X | X | | | | X | X |
| Fabric K | X | X | X | X | X | | |
| Fabric L | X | X | X | X | | X | |
| Fabric M | X | X | X | X | | | X |
| Fabric N | X | X | X | | X | X | |
| Fabric O | X | X | X | | X | | X |
| Fabric P | X | X | | X | X | X | |
| Fabric Q | X | X | | X | X | | X |
| Fabric R | X | X | | X | | X | X |
| Fabric S | X | X | X | | | X | X |
| Fabric T | X | X | | | X | X | X |
| Fabric U | X | | X | X | X | X | |
| Fabric V | X | | X | X | X | | X |
| Fabric W | X | | X | X | | X | X |
| Fabric X | | | X | | X | X | X |
| Fabric Y | X | | | X | X | X | X |
| Fabric Z | X | X | X | X | X | X | |
| Fabric A′ | X | | X | X | X | X | X |
| Fabric B′ | X | X | | X | X | X | X |
| Fabric C′ | X | X | X | | X | X | X |
| Fabric D′ | X | X | X | X | | X | X |
| Fabric E′ | X | X | X | X | X | | X |
| Fabric F′ | X | X | X | X | X | X | X |

As can be observed from the above, the concentration of graphene contained in the fabric remaining between 0.005% (w/w) to 1% (w/w), the further features of the fabric may vary with the restriction that at least three features selected from anti-microbial, antistatic, anti-odour, wicking, thermal cooling and ultraviolet protection are met. Each of the above combination of features is further characterized by features such as but not limited to good/excellent washing fastness, rubbing fastness, perspiration fastness, sublimation fastness and light fastness.

In some embodiments, the fabric of the present disclosure is characterized by an increase of about 1 fold to about 10 fold of anti-microbial, antistatic, anti-odour, wicking, thermal cooling and ultraviolet protection when compared to a fabric lacking graphene.

Accordingly, the fabric of the present disclosure is characterized by three of more of the following -
about 1 fold to about 10 fold increase in anti-microbial activity;
about 1 fold to about 10 increase in antistatic activity;
about 1 fold to about 10 increase in anti-odour activity;
about 1 fold to about 10 increase in wicking efficiency;
about 1 fold to about 10 increase in thermal cooling; and
about 1 fold to about 10 increase in ultraviolet protection when compared to a fabric lacking graphene.

In some embodiments, the fabric of the present disclosure is characterized by an increase of about 1 fold, about 2 fold, about 3 fold, about 4 fold, about 5 fold, about 6 fold, about 7 fold, about 8 fold, about 9 fold or about 10 fold in anti-microbial, antistatic, anti-odour, wicking, thermal cooling and ultraviolet protection when compared to a fabric lacking graphene.

In some embodiments, the anti-microbial activity comprises bactericidal or antibacterial effect, bacteriostatic effect, antiviral effect, antifungal effect or combinations thereof. In some embodiments, the fabric is characterized by a bactericidal effect ranging from about 90% to 99.999%, including all values or ranges derivable therefrom, against Staphylococcus aureus, Klebsiella pneumonia, and Escherichia coli.

In exemplary embodiments, the fabric is characterized by a bactericidal effect ranging from about 99.94% to 99.95%, including all values or ranges derivable therefrom, against Staphylococcus aureus, Klebsiella pneumonia, and Escherichia coli.

In some embodiments, the fabric is characterized by a bacteriostatic effect ranging from about 90% to 99.999%, including all values or ranges derivable therefrom, against Staphylococcus aureus, Klebsiella pneumonia, and Escherichia coli.

In some embodiments, the fabric is characterized by a bacteriostatic effect ranging from about 99% to 99.999%, including all values or ranges derivable therefrom, against Staphylococcus aureus, Klebsiella pneumonia, and Escherichia coli.

In some embodiments, the fabric is characterized by a bacteriostatic effect comprising log reduction of bacterial value ranging from about 3 to 5, including all values or ranges derivable therefrom, against Staphylococcus aureus, Klebsiella pneumonia, and Escherichia coli. In exemplary embodiments, the fabric is characterized by a bacteriostatic effect comprising log reduction of bacterial value ranging from about 3.25 to 4.22, against Staphylococcus aureus, Klebsiella pneumonia, and Escherichia coli.

In some embodiments, the fabric is characterized by an antiviral effect ranging from about 90% to 99.999%, including all values or ranges derivable therefrom, against M2 bacteriophage.

In some embodiments, the fabric is characterized by an antiviral effect ranging from about 99.9% to 99.999%, including all values or ranges derivable therefrom, against M2 bacteriophage.

In some embodiments, the fabric is characterized by an antiviral effect comprising a log reduction of virus value ranging from about 3 to 4 against M2 bacteriophage. In exemplary embodiments, the fabric is characterized by an antiviral effect comprising a log reduction of virus value ranging from about 3.66 to 3.93 against M2 bacteriophage.

In some embodiments, the fabric is characterized by an antifungal effect ranging from about 90% to 99.999%, including all values or ranges derivable therefrom, against Aspergillus niger and Candida albicans.

In exemplary embodiments, the fabric is characterized by an antifungal effect ranging from about 99.70% to 99.99% against Aspergillus niger and Candida albicans.

In some embodiments, the fabric is characterized by antistatic effect measured by half decay time for discharge of charge applied on the fabric surface which ranges from about 0.1 seconds to 3 seconds, including all values or ranges derivable therefrom. In some embodiments, the static discharge half decay time of the graphene incorporated fabric at a temperature of about 25° C. and at about 45% relative humidity ranges from about 0.5 seconds to 3 seconds.

In some embodiments, the fabric is characterized by anti-odour effect measured by AATCC 100 standard which ranges from about 90% to 99.999%, including all values or ranges derivable therefrom.

In some embodiments, the fabric is characterized by wicking effect measured by AATCC 197:2013 standard which ranges from about 2 inches/3 minutes to about 5 inches/30 minutes, including all values or ranges derivable therefrom.

In some embodiments, the fabric is characterized by thermal cooling measured by Q-Max which ranges from about 0.1 watts per square centimeter (W/cm²) to 0.7 W/cm², including all values or ranges derivable therefrom.

In some embodiments, the fabric is characterized by ultraviolet protection measured by ultraviolet protection factor (UPF) which ranges from about 30 to 70, including all values or ranges derivable therefrom.

In some embodiments, the fabric of the present disclosure has washing fastness, perspiration fastness, sublimation fastness and light fastness of about 4 to 5 as measured on a standard rating scale wherein 1-is very poor, 2-3 is good, 3-4 is very good and 4- 5 is excellent.

In some embodiments, the fabric of the present disclosure has water absorbency of about 0.1 seconds to about 5 seconds, including all values or ranges derivable therefrom.

In some embodiments, the anti-microbial, antistatic, anti-odour, wicking, thermal cooling and ultraviolet protection features of the fabric of the present disclosure are maintained after 30 washes or more.

In some embodiments, the anti-microbial, antistatic, anti-odour, wicking, thermal cooling and ultraviolet protection features of the fabric of the present disclosure are maintained even after at least 50 washes of the fabric.

In some embodiments of the present disclosure, the graphene incorporated fabric comprises graphene and/or its derivatives at a concentration ranging from about 0.005 % (w/w) to 0.2 % (w/w). In some embodiments of the present disclosure, the graphene incorporated fabric comprises graphene and/or its derivatives at a concentration ranging from about 0.01 % (w/w) to 0.2 % (w/w) (w/w). In exemplary embodiments of the present disclosure, the graphene incorporated fabric comprises graphene and/or its derivatives at a concentration of about 0.01 % (w/w) to about 0.05 % (w/w). In another exemplary embodiment, the graphene incorporated fabric comprises graphene and/or its derivatives at a concentration of about 0.02 % (w/w) to about 0.025 % (w/w). In a non-limiting embodiment, the graphene incorporated fabric comprises graphene and/or its derivatives at a concentration of about 0.005% (w/w), about 0.015%(w/w), about 0.02%(w/w), about 0.025%(w/w), about 0.03%(w/w), about 0.035%(w/w), about 0.04%(w/w), about 0.045%(w/w), about 0.05%(w/w), about 0.055%(w/w), about 0.06%(w/w), about 0.065%(w/w), about 0.07%(w/w), about 0.075%(w/w), about 0.08%(w/w), about 0.085%(w/w), about 0.09%(w/w), about 0.095%(w/w), about 0.1%(w/w), about 0.15%(w/w), about 0.2%(w/w), about 0.25%(w/w), about 0.3%(w/w), about 0.35%(w/w), about 0.40%(w/w), about 0.45%(w/w), about 0.5%(w/w), about 0.55%(w/w), about 0.6%(w/w), about 0.65%(w/w), about 0.7%(w/w), about 0.75%(w/w), about 0.8%(w/w), about 0.85%, about 0.9%(w/w), about 0.95% (w/w)or about 1%(w/w).

In embodiments of the present disclosure, the graphene derivatives are selected from a group comprising monolayer graphene, bilayer graphene, trilayer graphene, few layer graphene, multi-layer graphene, graphene nanoplatelets, graphene oxides, reduced graphene oxides, functionalized graphene, graphene decorated with metal particles, nanosized graphene, graphene quantum dots, any graphene containing material, and combinations thereof.

In embodiments of the present disclosure, the graphene incorporated fabric product is a dyed fabric product obtained after subjecting the fabric to dyeing technique(s) in presence of graphene and/or derivative(s) thereof. Accordingly, the graphene incorporated fabric product of the present disclosure may further comprise dyeing/coating agents or components.

In embodiments of the present disclosure, the fabric is selected from a group comprising natural fabric, synthetic fabric, blend of natural fabric and synthetic fabric, and combinations thereof.

In embodiments of the present disclosure, the natural fabric is selected from a group comprising fabric derived from Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein and combinations thereof.

In embodiments of the present disclosure, the synthetic fabric is selected from a group comprising Acetate, Acrylic, Lyocell, Modacrylic, Microfibre, Nomex, Nylon, Polyester, Polypropylene, Polyvinyl chloride, Rayon/Viscose, Spandex, Kevlar and combinations thereof.

In embodiments of the present disclosure, the blended fabric is a fabric derived from any combination of materials selected from a group comprising Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein, Acetate, Acrylic, Lyocell, Modacrylic, Microfibre, Nomex, Nylon, Polyester, Polypropylene, Polyvinyl chloride, Rayon/Viscose, Spandex and Kevlar.

In another embodiment, the graphene is incorporated into the fabric in the form of a coat on the surface of the fabric or is infused into the fibre network of the fabric, or a combination of both.

In a preferred embodiment of the present disclosure, the graphene is incorporated into the fabric on the surface of the fabric as well as infused into the fibre network of the fabric.

In embodiments of the present disclosure, graphene which is an atom thick honeycomb lattice of carbon possess extraordinary anti-microbial properties along with mechanical, thermal, electrical properties. Based on the number of stacking of layers in each entity, the graphene is classified as monolayer, bi-layer, tri-layer and multilayer. The physical structure and chemically functionalized groups of the graphene has the ability to kill and control the growth of microorganisms and therefore provides anti-bacterial activity to graphene. The atom thick sheets of carbon have sharp edges and spikes that act as a sharp knife which cause irreversible damages to the cell membranes of the bacteria and kills them. Additionally, in another mechanism, the bacteria/microbes are wrapped by large sheets of graphene and get killed. The functionalized groups of graphene react chemically with the anti-oxidant groups of the bacteria (GSH- glutathione) in the cell membrane that oxidises said anti-oxidant groups of bacteria and induces oxidative stress which kill the bacteria. Accordingly, due to the above mechanisms and the synergetic effect of physical and chemical destructions to the cell membranes of bacteria, graphene is considered as a strong antibacterial/anti-microbial agent and provide better/improved antibacterial/anti-microbial activity compared to the currently available anti-microbial agents.

In addition to the above, the atom thick honey-comb carbon based lattice structure of graphene possesses extraordinary electrical properties due to overlapping of π-orbitals. The in-plane electrical conductivity of monolayer graphene is about 1 × 10⁻⁶ ohm.cm with an electron mobility of about 200000 cm²/Vs. Based on the number of stacked layers in each entity the graphene is classified as monolayer, bi-layer, tri-layer and multilayer. Coating or infusing graphene in fabrics greatly enhances the electrical conductivity and thus improves the anti-static property of the fabrics. Accordingly, due to the above properties of graphene, graphene is considered to confer to fabrics more efficient and durable anti-static properties as compared to the currently available anti-static agents. In some embodiments, infusion of subtle quantity of graphene into fabrics, for instance at least about 0.01 wt% of with respect to the weight of the fabric [grams per square metre (GSM) of fabric], particularly a fabric having GSM ranging from about 50 GSM to 500 GSM, effectively reduces resistivity of the fabric from about 1016 ohm.cm to less than about 109 ohm.cm, allowing for quick dissipation of charges from the fabric surface, thus leading to anti-static property of the treated fabric. This helps prevent build-up of static electricity in the fabric and helps overcome triboelectric effect arising from rubbing of the fabric. Anti-static agents typically employed in the art increase the electrical conductivity of the fabric by forming hygroscopic intermediate layers on the fabric surface that absorb moisture and enhance conductivity. However, said absorption of moisture for achieving anti-static effect interferes with properties of the fabric such as wicking and thermal cooling, which are important for breathability of the fabric. Said properties of wicking and thermal cooling are extremely important for the comfort of the wearer especially in the case of garments such as sportswear or uniforms wherein in addition to features such as anti-static and anti-microbial, features such as wicking and thermal cooling of the fabric are also important for purposes of hygiene and comfort. Accordingly, the present invention provides a simple yet effective solution to said problem by providing a simple fabric that has all of the aforesaid properties additionally along with UV protection.

The present disclosure further relates to the preparation/production of graphene incorporated fabric. In embodiments of the present disclosure, the production of graphene incorporated fabric comprises incorporating graphene and/or its derivatives in the fabric by techniques such as but not limited to coating and/or dyeing.

Accordingly, the present disclosure further provides a method of preparing a fabric comprising about 0.005% (w/w) to 1% (w/w) graphene, said fabric characterized by a combination of at least three features selected from anti-microbial, antistatic, anti-odour, wicking, thermal cooling and ultraviolet protection, the method comprising contacting graphene with a fabric.

In some embodiments, in the method of preparing the graphene incorporated fabric of the present disclosure, the step of contacting the graphene comprises:
a) preparing a coating solution comprising graphene slurry; and
b) coating or dyeing a fabric with the coating solution, to prepare the graphene incorporated fabric.

The ‘coating solution’ as referred to herein comprises graphene and/or its derivatives along with two or more coating or dyeing agents/components, wherein said coating solution is employed in dyeing/coating a fabric to obtain the graphene incorporated fabric of the present disclosure.

In some embodiments, contacting the graphene comprises:
a) preparing a coating solution comprising graphene slurry; and
b) contacting the fabric with the coating solution, to prepare the fabric comprising graphene.

In some embodiments, the coating solution is prepared by:
i) dispersing graphene in a solvent and optionally a surfactant followed by mixing, to prepare the graphene slurry; and
ii) mixing the graphene slurry with two or more agents selected from the group comprising wetting agent, dispersing agent, lubricating agent, defoaming agent, pH control agent, fabric coating agent, and combinations thereof.

In some embodiments, the coating solution is prepared by:
i) dispersing graphene in a solvent and optionally a surfactant followed by mixing, to prepare the graphene slurry; and
ii) mixing the graphene slurry with two or more agents selected from the group comprising wetting agent, dispersing agent, lubricating agent, defoaming agent, pH control agent, fabric coating agent, and combinations thereof.

In some embodiments, the coating solution is prepared by:
i) dispersing graphene in a solvent and optionally a surfactant followed by mixing, to prepare the graphene slurry; and
ii) mixing the graphene slurry with three or more agents selected from the group comprising wetting agent, dispersing agent, lubricating agent, defoaming agent, pH control agent, fabric coating agent, and combinations thereof.

In some embodiments, the coating solution is prepared by:
i) dispersing graphene in a solvent and optionally a surfactant followed by mixing, to prepare the graphene slurry; and
ii) mixing the graphene slurry with four or more agents selected from the group comprising wetting agent, dispersing agent, lubricating agent, defoaming agent, pH control agent, fabric coating agent, and combinations thereof.

In some embodiments, the solvent is selected from a group comprising water, alcohol, hydrocarbon and combinations thereof.

In some embodiments, the surfactant is selected a group comprising polyvinylpyrrolidone (PVP), sodium dodecyl sulfate (SDS), sodium lauryl sulfate (SLS), Sodium lauryl ether sulfate (SLES), Silicon and combinations thereof.

In some embodiments, the mixing in steps i) and ii) may be conducted by any method routinely practiced in the art that serves the purpose of combining the components.

In exemplary embodiments, the mixing in step i) is carried out at a mixing rate of about 100 RPM to 10,000 RPM. In some embodiments, the mixing of the graphene slurry and the agent in step ii) is carried out at a mixing rate of about 100 RPM to 1000 RPM.

In some embodiments of the present disclosure, the preparation of the coating solution comprises contacting or dispersing graphene and/or its derivatives in a solvent and optionally along with a surfactant, in a high shear mixer, to prepare the graphene slurry, followed by mixing the slurry with two or more coating/dyeing agents such as but not limited to wetting agent, dispersing agent, lubricating agent, defoaming agent, pH control agent and other standard/conventional coating agents, or combinations thereof. In an embodiment, the prepared graphene slurry is a homogenous slurry or concentrated slurry which is further mixed with two or more coating/dyeing agents as described above to prepare the coating solution which is employed as a graphene source for coating and/or dyeing fabric.

In exemplary embodiments, step i) in the above described method comprises preparing the graphene slurry by dispersing the graphene in the solvent and the surfactant followed by mixing.

In some embodiments, the ratio between the graphene and the surfactant in the graphene slurry ranges from about 1:280 to 2:1. Said graphene slurry is mixed with two or more coating/dyeing agents to obtain the coating solution.

In some embodiments, the coating solution comprises graphene at a concentration of about 0.1 wt% to 7 wt%.

In some embodiments, the coating solution comprises graphene at a concentration of about 0.5 wt% to 7 wt%.

In some embodiments, the coating solution comprises graphene at a concentration of about 1 wt% to 7 wt%.

In some embodiments, the coating solution comprises graphene at a concentration of about 1 wt% to 2 wt%.

In some embodiments, the coating solution comprises graphene at a concentration of about 0.1 wt% to 0.5 wt%.

In some embodiments, the coating solution comprises graphene at a concentration of about 0.1 wt%, about 0.5%, about 1 wt%, about 1.5 wt%, about 2 wt%, about 2.5 wt%, about 3 wt%, about 3.5 wt%, about 4 wt%, about 4.5 wt%, about 5 wt%, about 5.5 wt%, about 6 wt%, about 6.5 wt% or about 7 wt%.

In some embodiments, the coating solution is prepared to comprise graphene at a concentration higher than that at which it is present in the final fabric. Once the solution is prepared and applied to the fabric and said fabric is processed as explained in the present disclosure, the final fabric that is yielded comprises graphene at a concentration of about 0.005 wt% to 1 wt%, as defined herein.

In some embodiments, the wetting agent is selected from the group comprising cationic agent, anionic agent, non-ionic agent, amphoteric agent and combinations thereof.

In some embodiments, when present in the coating solution, the wetting agent is in an amount of about 0.1% to 1% (w/w), including all values or ranges derivable therefrom.

In a non-limiting embodiment, the wetting agent is present in the coating solution at a concentration of about 0.1 wt%, about 0.2 wt%, about 0.3 wt%, about 0.4 wt%, about 0.5 wt%, about 0.6 wt%, about 0.7 wt%, about 0.8 wt%, about 0.9 wt% or about 1 wt%.

In some embodiments, the dispersing agent is selected from the group comprising cationic agent, anionic agent, non-ionic agent, amphoteric agent and combinations thereof.

In some embodiments, the dispersing agent, when present in the coating solution, is in an amount of about 0.05% to 14% (w/w), including all values or ranges derivable therefrom.

In a non-limiting embodiment, the dispersing agent is present in the coating solution at a concentration of about 0.05 wt%, about 2 wt%, about 3 wt%, about 4 wt%, about 5 wt%, about 6 wt%, about 7 wt%, about 8 wt%, about 9 wt%, about 10 wt%, about 11 wt%, about 12 wt%, about 13 wt% or 14 wt%.

In some embodiments, the lubricating agent is selected from the group comprising polyglycol ethers, silicone-based lubricant, mineral oil-based lubricant, other non-ionic lubricants and combinations thereof.

In some embodiments, when present in the coating solution, the lubricating agent is in an amount of about 0.01% to 1% (w/w), including all values or ranges derivable therefrom.

In a non-limiting embodiment, the lubricating agent is present in the coating solution at a concentration of about 0.01 wt%, about 0.1 wt%, about 0.2 wt%, about 0.3 wt%, about 0.4 wt%, about 0.5 wt%, about 0.6 wt%, about 0.7 wt%, about 0.8 wt%, about 0.9 wt% or about 1 wt%.

In some embodiments, defoaming agent is selected from the group comprising polyether, silicone polyether, and a combination thereof.

In some embodiments, when present in the coating solution, the defoaming agent is in an amount of about 0.1% to 2% (w/w), including all values or ranges derivable therefrom.

In a non-limiting embodiment, the defoaming agent is present in the coating solution at a concentration of about 0.1 wt%, about 0.2 wt%, about 0.3 wt%, about 0.4 wt%, about 0.5 wt%, about 0.6 wt%, about 0.7 wt%, about 0.8 wt%, about 0.9 wt%, about 1 wt%, 1.1 wt%, about 1.2 wt%, about 1.3 wt%, about 1.4 wt%, about 1.5 wt%, about 1.6 wt%, about 1.7 wt%, about 1.8 wt%, about 1.9 wt% or about 2 wt%.

In some embodiments, the pH control agent is selected from the group comprising Auxigreen acid, citric acid, acetic acid and combinations thereof.

In some embodiments, when incorporated into the coating solution, the pH control agent is present in the coating solution in an amount of about 0.1% to 1% (w/w), including all values or ranges derivable therefrom.

In a non-limiting embodiment, the pH control agent is present in the coating solution at a concentration of about 0.1 wt%, about 0.2 wt%, about 0.3 wt%, about 0.4 wt%, about 0.5 wt%, about 0.6 wt%, about 0.7 wt%, about 0.8 wt%, about 0.9 wt% or about 1 wt%.

In some embodiments, the fabric is contacted with the coating solution by a dyeing technique selected from the group comprising high temperature high pressure (HTHP) dyeing, jet dyeing, screen printing, jigger dyeing, winch dyeing, beam dyeing, padding, foam coating and combinations thereof. In an embodiment of the present disclosure, the coating or dyeing technique described above comprises a dyeing cycle, optionally followed by one or more of reduction clearing cycle, acid neutralization, washing, and drying to obtain the final anti-static fabric.

In some embodiments, the method of preparing the graphene incorporated fabric of the present disclosure comprises:
a. preparing the graphene slurry;
b. mixing the graphene slurry with the agent selected from the group comprising wetting agent, dispersing agent, lubricating agent, defoaming agent, pH control agent, fabric coating agent and combinations thereof, to obtain a coating solution; and
c. contacting a fabric with the coating solution, to prepare the fabric comprising graphene at an amount ranging from about 0.005% (w/w) to 1% (w/w), said fabric characterized by the combination of at least three features selected from anti-microbial, antistatic, anti-odour, wicking, thermal cooling and ultraviolet protection.

In some embodiments, the method of preparing the graphene incorporated fabric of the present disclosure comprises:
a. preparing the graphene slurry;
b. preparing a solution comprising wetting agent, dispersing agent, lubricating agent, defoaming agent, pH control agent, fabric coating agent, or any combination thereof; and
c. contacting a fabric with the graphene slurry and the solution of step b) to prepare the fabric comprising graphene at an amount ranging from about 0.005% (w/w) to 1% (w/w), said fabric characterized by the combination of at least three features selected from anti-microbial, antistatic, anti-odour, wicking, thermal cooling and ultraviolet protection.

In an embodiment of the present disclosure, dyeing the fabric comprises dyeing with the graphene slurry followed by adding the solution of step b) above.

In another embodiment of the present disclosure, dyeing the fabric comprises dyeing with the solution of step b) described above followed by adding the graphene slurry.

In a further embodiment of the present disclosure, dyeing the fabric comprises simultaneously dyeing with the solution of step b) and the graphene slurry.

In some exemplary embodiments of the present disclosure, the method comprises:
a. preparing graphene slurry by dispersing graphene and/or its derivatives in water, optionally along with a surfactant, in a high shear mixer;
b. mixing the graphene slurry with two or more coating agents to obtain a coating solution; and
c. jet dyeing of a fabric with the coating solution, to prepare the graphene incorporated fabric.

In some exemplary embodiments of the present disclosure, the production of graphene incorporated fabric comprises:
a. preparing graphene slurry by dispersing graphene and/or its derivatives in water, optionally along with a surfactant, in a high shear mixer;
b. mixing the graphene slurry with two or more coating agents to obtain a coating solution; and
c. screen printing of a fabric with the coating solution, to prepare the graphene incorporated fabric.

In an exemplary embodiment of the present disclosure, the production of graphene incorporated fabric further comprises:
performing reduction clearing, and
carrying out acid neutralization, washing and drying, to prepare the graphene incorporated fabric.

Accordingly, in some embodiments, contacting a fabric with the coating solution comprises:
a. dyeing a fabric with the coating solution (dyeing cycle);
b. performing reduction clearing, and
c. carrying out acid neutralization, washing and drying, to prepare the graphene incorporated fabric.

In a non-limiting embodiment, the aforesaid method and described variants thereof coat the graphene on the surface of the fabric or infuses the graphene onto the fibre network of the fabric, or achieves a combination of both.

The fabric obtained by the aforesaid method retains the anti-microbial, antistatic, anti-odour, wicking, thermal cooling and ultraviolet protection features after 30 washes or more, preferably at least about 50 washes.

In some embodiments of the present disclosure, the preparation/production of graphene infused fabric is achieved by a one-step industrially adapted large-scale mass production dyeing process without the involvement of post processing techniques.

In some embodiments of the present disclosure, the graphene is infused/incorporated during synthesis/production of fabrics. In other embodiments of the present disclosure, the graphene is infused/incorporated in the synthesized/produced fabrics or virgin fabrics.

The present disclosure further relates to use of graphene for preparing a fabric comprising graphene at an amount ranging from about 0.005 to 1% (w/w) and characterized by a combination of at least three features selected from anti-microbial, antistatic, anti-odour, wicking, thermal cooling and ultraviolet protection.

In some embodiments, the use comprises preparing a coating solution comprising graphene at a concentration higher than that at which it is present in the final fabric and applying the same to the fabric. Once the solution is prepared and applied to the fabric and said fabric is processed as explained in the present disclosure, the final fabric that is yielded comprises graphene at a concentration of about 0.005 wt% to 1 wt%, as defined herein. In some embodiments, the aforesaid use comprises preparing a coating solution comprising graphene an amount ranging from about 0.1 wt% to 7 wt%, followed by its application to the fabric to yield a fabric comprising graphene at an amount ranging from about 0.005 to 1% (w/w).

As mentioned above, the graphene in the aforesaid use is a graphene, a graphene derivative or a combination thereof, wherein the graphene derivative.

In preferred embodiments, in the aforesaid use, the graphene is in the form of a graphene slurry or a graphene coating solution. In some embodiments, the graphene slurry comprises graphene, solvent and optionally a surfactant. In further embodiments, the graphene coating solution comprises the graphene slurry and two or more agents selected from the group comprising wetting agent, dispersing agent, lubricating agent, defoaming agent, pH control agent, fabric coating agent, and combinations thereof. Each of said agents referred to in the above method is defined in earlier embodiments.

To enable preparation of the graphene incorporated fabric of the present disclosure, the present disclosure further provides a graphene coating solution comprising graphene and at least two agents selected from the group comprising wetting agent, dispersing agent, lubricating agent, defoaming agent, pH control agent, fabric coating agent and combinations thereof, wherein the wetting agent, the dispersing agent, the lubricating agent, the defoaming agent and the pH control agent are defined in earlier embodiments are not repeated herein for reasons of brevity.

In some embodiments, the graphene coating solution comprises graphene and three or more agents selected from the group comprising wetting agent, dispersing agent, lubricating agent, defoaming agent, pH control agent, fabric coating agent and combinations thereof.

In some embodiments, the graphene coating solution comprises graphene and four or more agents selected from the group comprising wetting agent, dispersing agent, lubricating agent, defoaming agent, pH control agent, fabric coating agent and combinations thereof.

In some embodiments, the graphene coating solution comprises graphene, wetting agent(s), dispersing agent(s) and one or more agents selected from the group comprising wetting agent, dispersing agent, lubricating agent, defoaming agent, pH control agent, fabric coating agent and combinations thereof.

In some embodiments, the graphene in the coating solution is in a form of a graphene slurry comprising graphene, solvent and optionally a surfactant. The graphene in said slurry is a graphene, a graphene derivative or a combination thereof. In some embodiments, the ratio between the graphene and the surfactant in the graphene slurry ranges from about 1:280 to 2:1. Solvents, surfactants and graphene derivatives employable herein are defined in earlier embodiments.

In some embodiments, the graphene coating solution comprises graphene at a concentration of about 0.1 wt% to 7 wt%.

In some embodiments, the graphene coating solution comprises graphene at a concentration of about 0.5 wt% to 7 wt%.

In some embodiments, the graphene coating solution comprises graphene at a concentration of about 1 wt% to 7 wt%.

In some embodiments, the graphene coating solution comprises graphene at a concentration of about 1 wt% to 2 wt%.

In some embodiments, the graphene coating solution comprises graphene at a concentration of about 0.1 wt% to 0.5 wt%.

In some embodiments, the graphene coating solution comprises graphene at a concentration of about 0.1 wt%, about 0.5%, about 1 wt%, about 1.5 wt%, about 2 wt%, about 2.5 wt%, about 3 wt%, about 3.5 wt%, about 4 wt%, about 4.5 wt%, about 5 wt%, about 5.5 wt%, about 6 wt%, about 6.5 wt% or about 7 wt%.

In some embodiments, the coating solution is prepared to comprise graphene at a concentration higher than that at which it is present in the final fabric. Once the solution is prepared and applied to the fabric and said fabric is processed as explained in the present disclosure, the final fabric that is yielded comprises graphene at a concentration of about 0.005 wt% to 1 wt%, as defined herein.

In some embodiments, the coating solution comprises at least two of the following -
the wetting agent in an amount of about 0.1% to 1% (w/w), including all values or ranges derivable therefrom;
the dispersing agent in an amount of about 0.05% to 14% (w/w), including all values or ranges derivable therefrom;
the lubricating agent in an amount of about 0.01% to 1% (w/w), including all values or ranges derivable therefrom;
the defoaming agent in an amount of about 0.1% to 2% (w/w), including all values or ranges derivable therefrom; and
the pH control agent in an amount of about 0.1% to 1% (w/w), including all values or ranges derivable therefrom.

The present disclosure further provides a method of preparing the graphene coating solution as defined above, the method comprising:
i) dispersing graphene in a solvent and optionally a surfactant followed by mixing, to prepare a graphene slurry; and
ii) mixing the graphene slurry with two or more agents selected from the group comprising wetting agent, dispersing agent, lubricating agent, defoaming agent, pH control agent, fabric coating agent, and combinations thereof.

The graphene, solvent, surfactant, wetting agent, dispersing agent, lubricating agent, defoaming agent, pH control agent and the fabric coating agent employable in the above method are provided in earlier embodiments and are not repeated for reasons of brevity.

The present disclosure further provides use of the graphene infused fabric in applications/manufacture of commercial products such as but not limited to textile products in medical applications/hospitals such as aprons, garments, furniture covers, bed covers, pillow covers, curtains, other apparels, upholstery, carpets and bags.

To solve the need in the art for enhanced fabrics, the present disclosure provides fabric comprising graphene at relatively low concentration, to obtain the claimed fabric. Advantages of the fabric of the present disclosure include but are not limited to -
beneficial properties at low concentrations of graphene and/or its derivatives;
very good/excellent washing fastness, rubbing fastness, perspiration fastness, sublimation fastness and light fastness;
retention of the beneficial properties discussed above along with excellent washing, rubbing, perspiration, sublimation and light fastness features even after multiple washes of the fabric thus providing excellent stability to the fabric after repeated washing cycles;
enhanced anti-microbial, antistatic, anti-odour, wicking, thermal cooling and ultraviolet protection as compared to unprocessed fabrics;
economical, repeatable and commercially/industrially viable process for production.

While the present disclosure is susceptible to various modifications and alternative forms, specific aspects thereof have been shown by way of examples and drawings and are described in detail below. However, it should be understood that it is not intended to limit the invention to the particular forms disclosed, but on the contrary, the intention is to cover all modifications, equivalents, and alternatives falling within the spirit and the scope of the invention as defined by the appended claims.

### EXAMPLES

The present disclosure is further described with reference to the following examples, which are only illustrative in nature and should not be construed to limit the scope of the present disclosure in any manner.

### Example 1: Preparing Slurry Formulation

A water-based graphene slurry was prepared using high shear mixer comprising about 0.2 -7 wt% of graphene in water with or without surfactant such as PVP, SDS, etc. at a concentration of 0.001 - 2 wt% and in a ratio of 1:10 to 1:1 with graphene. The graphene and surfactants were shear mixed for about 1-2 hours to obtain a homogenous dispersed graphene water slurry which is used as a source of graphene in jet-dyeing experiments.

### Example 2: Coating Solution Preparation

A 200 L jet dyeing solution was prepared by mixing about 0.01-1 wt% of graphene with respect to the weight of the fabric to be dyed, along with other chemicals such as wetting agent 1 gram per liter (gpl), dispersing agent 1.5 gpl lubricating agent 1 gpl, defoaming agent 0.25 gpl, and pH control 3 gpl.

### Example 3: Preparation of Graphene Incorporated Fabric

Polyester Fabric of length of about 18 meters and width of about 1.5 meters was dyed in the machine at a peak temperature of about 130° C. and an RPM of about 27-30 as per the following dying cycle which is followed by reduction clearing cycle. The dyed fabric was acid neutralized, washed and dried to get the final anti-microbial/anti-odour fabric.

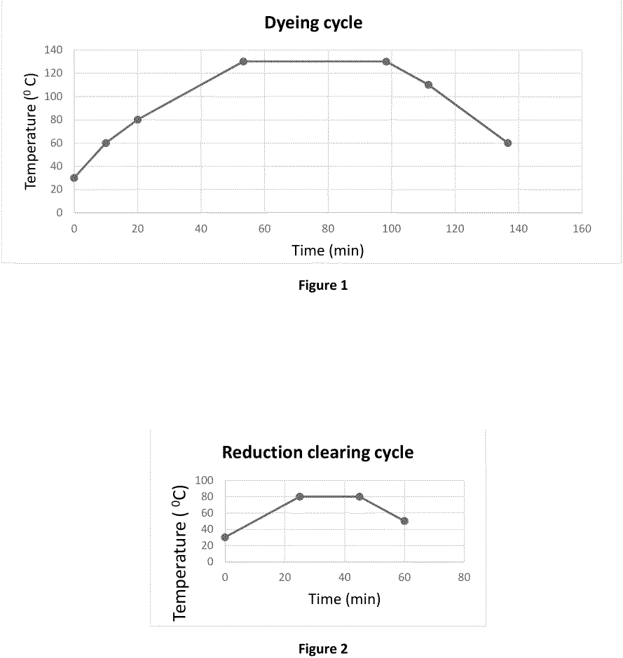

Temperatures employed during the drying cycle and the reduction clearing cycle are provided in tables 1 and 2. Said cycles are further depicted in FIGS. 1 and 2.

TABLE 2

Characteristics of Dyeing cycle

| Time (min) | Temp. (°C) |
|---|---|
| 0 | 30 |
| 10 | 60 |
| 20 | 80 |
| 53.33 | 130 |
| 98.33 | 130 |
| 111.66 | 110 |
| 136.66 | 60 |

Table 2 provides the data of dyeing cycle used to prepare the fabrics. The temperature of the fabric and the solution in the jet dyeing machine was raised to 60° C. in the first 10 minutes, 80° C. in the next 20 minutes and 130° C. in 53.33 minutes. The temperature was held at 130° C. till 98.33 minutes and decreased to 60° C. gradually. The fabric was held at a dyeing temperature of 130° C. for 45 minutes to accomplish dyeing.

TABLE 3

Characteristics of Reduction clearing cycle

| Time (min) | Temp (°C) |
|---|---|
| 0 | 30 |
| 25 | 80 |
| 45 | 80 |
| 60 | 50 |

Reduction clearing of the fabric was carried out at 80° C. for 20 minutes in the jet dyeing machine.

### Example 4: Analysis of Features of the Graphene Incorporated Fabric

The fabric as prepared in Example 3 was subjected to analysis of various properties reported in the present disclosure. The following observations were made:

TABLE 4

Analysis of features of the graphene incorporated fabric

| | | | | | |
|---|---|---|---|---|---|
| Feature Required | Standard | Standard values | Observation on Fabric | Inferences | Pass/Fail |
| Anti-static | ASTM D: 4238:90 | <2S Half Decay time | 0.9 S- 1.95 S | Good anti-static behaviour | Pass |
| Anti-bacterial | JIS L 1902-Bacteriostatic Act | Bacteriostatic Activity >2 for 1,10,25,50 washes SA-staphylococcus aureus KP-klebsiella pneumonia EC-Escherichia coli | SA:3.25-2.36 & 4.22 | Good bacteriostatic behaviour | Pass |
| | | | KP:3.32-2.30 &4.16 | | |
| | | | EC:3.28-2.33 | | |
| Anti-bacterial | JIS L 1902-Bactericidal Act. | 99-Fair;>99.5 -Very good; 99.99-Excellent SA-staphylococcus aureus KP-klebsiella pneumonia EC-Escherichia coli | SA:99.94-99.56& 99.99% | Very good bactericidal behaviour | Pass |
| | | | KP:99.95-99.5&99.99% | | |
| | | | EC:99.94-99.52 | | |
| Anti-viral | AATCC 100-2012 | Log reduction of Virus> 3.5 | 3.93-3.66 | Good anti-viral behaviour | Pass |
| | | M2 bacteriophage | | | |
| Anti-fungal | AATCC 100-2012 | >99%; | >99.7% | Good behaviour antifungal | Pass |
| | | Aspergillus niger and Candida albicans | | | |
| Anti-odour | AATCC100 | | >90%-99.999% | | Pass |
| Rubbing fastness (dry and wet) | ISO 105×12 | 3 to 5 | 4-5 | Good as per standards | Pass |
| Washing Fastness | ISO 105-C10 | 4 to 5 | 4-5 | Good as per standards | Pass |
| Sublimation fastness | ISO 105 P01 | 4-5 | 4-5 | Good as per standards | Pass |
| Perspiration Fastness | ISO 105 E04/AATCC 15 | 4-5 | 4-5 | Good as per standards | Pass |
| Wicking | – – | NA | 2 inches/3minutes | Good | Pass |
| | | | — | | |
| | | | 5 inches/30minutes | | |
| UV protection | AATCC 183 | 25-35 - good UV protection | 38 -55 | Good UV protection | Pass |
| | | ≥50 - excellent UV protection | | | |
| Thermal cooling | Kawabata-KES-F7 | --Dry state Wet state | 0.150 W/cm² -0.377 W/cm² | Good thermal cooling | Pass |
| Water absorbancy | AATCC 79 | 4.87 S- Control | 1.09 S (0.02 RFC1) | Excellent absorbency of water | Pass |

It was observed from the above that the fabric of the present disclosure possesses a minimum of three features of anti-microbial, antistatic, wicking, thermal cooling, anti-odour and ultraviolet protection, all favourable towards the comfort and safety of the wearer.

### Example 5: Preparation of Alternative Graphene Coating Solutions and Effects on Fabric Comprising the Same

Following the method of Example 2, the following alternative coating solutions were prepared -

Alternative graphene coating solution 1 - 200 L dyeing solution comprising 0.01-1 wt% of graphene with respect to the weight of the fabric to be dyed, along with other chemicals such as wetting agent 1 gram per liter (gpl), lubricating agent 1 gpl, defoaming agent 0.25 gpl, and pH control 3 gpl.

Alternative graphene coating solution 2 - 200 L dyeing solution comprising 0.01-1 wt% of graphene with respect to the weight of the fabric to be dyed, along with other chemicals such as dispersing agent 1.5 gpl, lubricating agent 1 gpl, defoaming agent 0.25 gpl, and pH control 3 gpl.

Graphene incorporated fabrics were prepared using the alternative coating solutions described above. The coating solution of Example 2 was employed for the purposes of comparison. The fabrics were prepared following the same methodology as Example 3.

The obtained fabrics were tested for the features of anti-microbial, antistatic, wicking, thermal cooling, anti-odour and ultraviolet protection. It was found that the alternative coating solutions 1 and 2, lacking dispersing agent and wetting agent, respectively, were unable to yield fabric having at least 3 features selected from anti-microbial, antistatic, wicking, thermal cooling, anti-odour and ultraviolet protection.

The above therefore shows that the absence of even one component from the aforesaid coating solution fails to yield the fabric of the present disclosure mandatorily characterized by at least 3 features selected from anti-microbial, anti-static, wicking, thermal cooling, anti-odour and ultraviolet protection. This establishes the synergy between the components of the graphene coating solution of the present disclosure.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps. The term “about” is used herein to mean approximately, in the region of, roughly, or around. When the term “about” is used in conjunction with a numerical value/range, it modifies that value/range by extending the boundaries above and below the numerical value(s) set forth. In general, the term “about” is used herein to modify a numerical value(s) above and below the stated value(s) by a variance of 20%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

All references, articles, publications, general disclosures etc. cited herein are incorporated by reference in their entireties for all purposes. However, mention of any reference, article, publication etc. cited herein is not, and should not be taken as, an acknowledgment or any form of suggestion that they constitute valid prior art or form part of the common general knowledge in any country in the world.

1) A fabric comprising graphene at an amount ranging from about 0.005% (w/w) to 1% (w/w), said fabric characterized by a combination of at least three features selected from antimicrobial, anti-static, anti-odour, wicking, thermal cooling and ultraviolet protection.

2) The fabric as claimed in claim 1, wherein the fabric is selected from the group comprising natural fabric, synthetic fabric, a blend of natural fabric and synthetic fabric, and combinations thereof; or wherein the graphene is present in the fabric in the form of a coat on the surface of the fabric or is infused into the fibre network of the fabric, or a combination of both; or wherein the graphene is at an amount ranging from about 0.01% (w/w) to 1% (w/w) with respect to the weight of the fabric.

3) (canceled)

4) The fabric as claimed in claim 1, wherein the fabric is characterized by the combination of at least four features selected from antimicrobial, antistatic, anti-odour, wicking, thermal cooling and ultraviolet protection; or
wherein the fabric is characterized by the combination of anti-microbial, anti-static, anti-odour, wicking, thermal cooling and ultraviolet protection features.

5) (canceled)

6) The fabric as claimed in claim 1, wherein the fabric is characterized by an increase of 1 fold to 10 fold of antimicrobial, antistatic, anti-odour, wicking, thermal cooling and ultraviolet protection when compared to a fabric lacking graphene, or
wherein the fabric comprises bactericidal or antibacterial effect, bacteriostatic effect, antiviral effect_{.} antifungal effect or combinations thereof;
wherein the fabric is characterized by a bactericidal effect ranging from about 90% to 99_{.}999% against Staphylococcus aureus, Klebsiella pneumonia, and Escherichia coli;
wherein the fabric is characterized by a bacteriostatic effect ranging from about 90% to 99.999% against Staphylococcus aureus, Klebsiella pneumonia, and Escherichia coli;
wherein the fabric is characterized by an antiviral effect ranging from about 90% to 99.999% against MS2 bacteriophage; or
wherein the fabric is characterized by an antifungal effect ranging from about 90% to 99.999% against Aspergillus Niger and Candida Albicans.

7) (canceled)

8) The fabric as claimed in claim 1, wherein the fabric comprises bactericidal or antibacterial effect, bacteriostatic effect, antiviral effect, antifungal effect or combinations thereof;
wherein the fabric is characterized by a bactericidal effect ranging from about 99.94% to 99.95% against Staphylococcus aureus, Klebsiella pneumonia, and Escherichia coli;
wherein the fabric is characterized by a bacteriostatic effect ranging from about 99% to 99.999% against Staphylococcus aureus, Klebsiella pneumonia, and Escherichia coli;
wherein the fabric is characterized by an antiviral effect ranging from about 99.9% to 99.999% against M2 bacteriophage; or
wherein the fabric is characterized by an antifungal effect ranging from about 99.70% to 99.99% against Aspergillus Niger and Candida Albicans; or
wherein the fabric is characterized by antistatic effect measured by, half decay time for discharge of charge applied on the fabric surface which ranges from about 0.1 seconds to 3 seconds, anti-odour effect measured by AATCC 100 standard which ranges from about 90% to 99.999%, wicking effect measured by AATCC 197:2013 standard which ranges from about 2 inches/3minutes to about 5 inches/30minutes, thermal cooling measured by Q-Max which ranges from about 0.1 watts per square centimeter (W/cm2) to 0.7 W/cm2. and ultraviolet protection measured by ultraviolet protection factor (UPF) which ranges from about 30 to 70; or
wherein said fabric has a washing fastness, perspiration fastness, sublimation fastness and light fastness of about 4 to 5; and water absorbency of 0.1 Sec to 5 Sec.; or
wherein the antimicrobial, antistatic, anti-odour, wicking, thermal cooling and ultraviolet protection features are maintained after 30 washes or more.

9) (canceled)

10) (canceled)

11) (canceled)

12) The fabric as claimed in claim 1, wherein the graphene is a graphene, a graphene derivative or a combination thereof, or
wherein the graphene derivative is selected from the group comprising monolayer graphene, bilayer graphene, trilayer graphene, few layer graphene, multi-layer graphene, graphene nanoplate-lets, graphene oxides, reduced graphene oxides, functionalized graphene, graphene decorated with metal particles, nanosized graphene, graphene quantum dots, any graphene containing material, and combinations thereof.

13) (canceled)

14) (canceled)

15) A method of preparing the fabric as claimed in claim 1.

16) The method as claimed in claim 15, wherein contacting the graphene comprises:
a) preparing a coating solution comprising graphene slurry; and
b) contacting the fabric with the coating solution, to prepare the fabric comprising graphene.

17) The method as claimed in claim 16, wherein the coating solution is prepared by:
i) dispersing graphene in a solvent and optionally a surfactant followed by mixing, to prepare the graphene slurry; and
ii) mixing the graphene slurry with at least two agents selected from the group comprising wetting agent, dispersing agent, lubricating agent, defoaming agent, pH control agent, fabric coating agent, and combinations thereof;
wherein the solvent is selected from the group comprising water, alcohol, hydrocarbon and combinations thereof;
the surfactant is selected from the group comprising polyvinylpyrrolidone (PVP), sodium dodecyl sulfate (SDS), sodium lauryl sulfate (SLS), Sodium lauryl ether sulfate (SLES), Silicon and combinations thereof;
the mixing in step i) is carried out at a mixing rate of about 100 RPM to 10,000 RPM; and the mixing of the graphene slurry and the agent in step ii) is carried out at a mixing rate of about 100 RPM to 1000 RPM; or
wherein step i) comprises preparing the graphene slurry by dispersing the graphene in the solvent and the surfactant followed by mixing; and wherein the ratio between the graphene and the surfactant in the graphene slurry ranges from about 1:280 to 2:1.; or
wherein the graphene in the coating solution is in an amount of about 0.1 wt% to 7 wt%;
the wetting agent is in an amount of about 0.1% to 1% (w/w) and said wetting agent is selected from the group comprising cationic agent, anionic agent, non-ionic agent, amphoteric agent and combinations thereof;
the dispersing agent is in an amount of about 0.05% to 14% (w/w) and said dispersing agent is selected from the group comprising cationic agent, anionic agent, non-ionic agent, amphoteric agent and combinations thereof;
the lubricating agent is in an amount of about 0.01% to 1% (w/w) and said lubricating agent is selected from the group comprising polyglycol ethers, silicone based lubricant, mineral oil based lubricant, other non-ionic lubricants and combinations thereof;
the defoaming agent is in an amount of about 0.1 % to 2% (w/w) and said defoaming agent is selected from the group comprising polyether, silicone polvether_{,} and a combination thereof; and.

18) (canceled)

19) (canceled)

20) (canceled)

21) The method as claimed in claim 16, wherein the fabric is contacted with the coating solution by a dyeing technique selected from the group comprising high temperature high pressure (HTHP) dyeing, jet dyeing, screen printing, jigger dyeing, winch dyeing, beam dyeing, padding, foam coating and combinations thereof.

22) The method as claimed in claim 15,
wherein the method comprises:
a. preparing the graphene slurry;
b. mixing the graphene slurry with the agent selected from the group comprising wetting agent, dispersing agent, lubricating agent, defoaming agent, pH control agent, fabric coating agent and combinations thereof, to obtain a coating solution; and
c. contacting a fabric with the coating solution, to prepare the fabric comprising graphene at an amount ranging from about 0.005% (w/w) to 1% (w/w), said fabric characterized by the combination of at least three features selected from antimicrobial, antistatic, anti-odour, wicking, thermal cooling and ultraviolet protection.

23) The method as claimed in claim 15,
wherein the method comprises:
a. preparing the graphene slurry;
b. preparing a solution comprising wetting agent, dispersing agent, lubricating agent, defoaming agent, pH control agent, fabric coating agent, or any combination thereof; and
c. contacting a fabric with the graphene slurry and the solution of step b) to prepare the fabric comprising graphene at an amount ranging from about 0.005% (w/w) to 1% (w/w), said fabric characterized by the combination of at least three features selected from antimicrobial, antistatic, anti-odour, wicking, thermal cooling and ultraviolet protection.

24) The method as claimed in claim 15, wherein the method coats the graphene on the surface of the fabric or infuses the graphene onto the fibre network of the fabric, or a combination of both; or
wherein the fabric obtained by the method retains the antimicrobial, antistatic, anti-odour, wicking, thermal cooling and ultraviolet protection features after 30 washes or more.

25) (canceled)

26) Use of graphene for preparing a fabric comprising graphene at an amount ranging from about 0.005 to 1% (w/w) and characterized by a combination of at least three features selected from antimicrobial, antistatic, anti-odour, wicking, thermal cooling and ultraviolet protection.

27) The use as claimed in claim 26, said use comprising coating the graphene on a fabric at an amount ranging from about 0.01 to 1% (w/w);
wherein the graphene is a graphene, a graphene derivative or a combination thereof, wherein the graphene derivative is as defined in the preceding claims;
wherein the graphene is in the form of a graphene slurry or a graphene coating solution;
wherein the graphene slurry comprises graphene, solvent and optionally a surfactant; and
wherein the graphene coating solution comprises the graphene slurry and at least two agents selected from the group comprising wetting agent, dispersing agent, lubricating agent, defoaming agent, pH control agent, fabric coating agent, and combinations thereof.

28) (canceled)

29) (canceled)

30) A graphene coating solution comprising graphene and at least two agents selected from the group comprising wetting agent, dispersing agent, lubricating agent, defoaming agent, pH control agent, fabric coating agent and combinations thereof, wherein the wetting agent, the dispersing agent, the lubricating agent, the defoaming agent and the pH control agent is as defined in the preceding claims.

31) The graphene coating solution as claimed in claim 30, wherein the graphene is in a form of a graphene slurry comprising graphene, solvent and optionally a surfactant, wherein the solvent and surfactant is as defined in the preceding claims, and wherein the graphene is present at a concentration of about 0.1 wt% to 7 wt%; or
wherein the graphene is a graphene, a graphene derivative or a combination thereof,
and wherein the graphene derivative is as defined in the preceding claims.

32) (canceled)

33) A method of preparing the graphene coating solution as claimed in claim 30, the method comprising:
i) dispersing graphene in a solvent and optionally a surfactant followed by mixing, to prepare a graphene slurry; and
ii) mixing the graphene slurry with at least two agents selected from the group comprising wetting agent, dispersing agent, lubricating agent, defoaming agent, pH control agent, fabric coating agent, and combinations thereof; and
wherein the graphene, solvent, surfactant, wetting agent, dispersing agent, lubricating agent, defoaming agent, pH control agent and the fabric coating agent are as defined in the preceding claims.
